(19) United States
(12) Patent Application Publication
(10) Pub. No.: US 2026/0369682 A1
(43) Pub. Date: Nov. 19, 2026

(54) BATTERY

(71) Applicant: TOYOTA JIDOSHA KABUSHIKI KAISHA, Toyota-shi (JP)

(72) Inventors: Ryosuke OHSAWA, Okazaki-shi (JP); Junta TAKASU, Nagoya-shi (JP)

(73) Assignee: TOYOTA JIDOSHA KABUSHIKI KAISHA, Toyota-shi (JP)

(21) Appl. No.: 19/535,384

(22) Filed: Feb. 10, 2026

(30) Foreign Application Priority Data
May 16, 2025 (JP) 2025-082774

(51) Int. Cl. H01M 10/0583; H01M 4/13; H01M 10/0525; H01M 50/531

(52) U.S. Cl. CPC H01M 10/0583; H01M 4/13; H01M 10/0525; H01M 50/531

(57) ABSTRACT

A battery includes an electrode body and an electrolytic solution. The electrode body includes a separator and a plurality of electrode sheets. A plurality of folded-back portions is formed by folding the separator in a zigzag shape. The electrode sheets are stacked by alternately inserting the electrode sheets into the folded-back portions. A collector portion is provided at an end portion of the electrode sheet. A groove group is provided on a surface of at least one electrode sheet. The groove group includes a first pattern portion and a second pattern portion. In a plan view, the second pattern portion is disposed between the collector portion and the first pattern portion. In the first pattern portion, the groove group extends toward the folded-back portion. In the second pattern portion, the groove group extends to be inclined toward a collector portion side with respect to the first pattern portion.

### CROSS-REFERENCE TO RELATED APPLICATION

This application claims priority to Japanese Patent Application No. 2025-082774 filed on May 16, 2025. The disclosure of the above-identified application, including the specification, drawings, and claims, is incorporated by reference herein in its entirety.

### BACKGROUND

### 1. Technical Field

The present disclosure relates to a battery.

### 2. Description of Related Art

Japanese Unexamined Patent Application Publication No. 2016-143550 (JP 2016-143550 A) discloses a stacked structure in which a positive electrode plate and a negative electrode plate are interposed in a separator folded in a zigzag shape.

### SUMMARY

An electrode body structure (zigzag structure) in which electrode sheets are alternately inserted into a separator folded in a zigzag shape has been proposed. However, since liquid circulation of an electrolytic solution in an electrode body is not smooth, for example, a desired rapid charging performance may not be obtained.

An object of the present disclosure is to improve liquid circulation in a zigzag structure.

Hereinafter, technical configurations and effects of the present disclosure will be described. However, an action mechanism includes an estimation. The action mechanism does not limit the technical scope of the present disclosure.

1. A battery according to one aspect of the present disclosure includes an electrode body and an electrolytic solution. The electrode body includes a separator and a plurality of electrode sheets. The separator folded in in a zigzag shape has a plurality of folded-back portions. The electrode sheets are stacked such that the electrode sheets are alternately interposed between the folded-back portions. A collector portion is provided at an end portion of each of the electrode sheets. A groove group is provided in a surface of at least one of the electrode sheets. The groove group includes a first pattern portion and a second pattern portion. In a plan view, the second pattern portion is disposed between the collector portion and the first pattern portion. In the first pattern portion, the groove group extends toward the folded-back portion. In the second pattern portion, the groove group extends to be inclined toward the collector portion with respect to the first pattern portion.

The groove group is provided in the surface of the electrode sheet. It is expected that the groove group will be a flow passage of the electrolytic solution. The groove group includes two planar patterns. In the first pattern portion, the groove group extends toward the folded-back portion of the separator. Since the folded-back portion is closed by the separator, the vicinity of the folded-back portion tends to be difficult for the electrolytic solution to permeate from the outside of the electrode body, and a liquid shortage tends to occur. It is expected that the liquid circulation in the vicinity of the folded-back portion is improved by the groove group having a first pattern. However, in the folded-back portion, since the electrolytic solution is a dead end, the electrolytic solution that has reached the folded-back portion also tends to be stagnant. During rapid charging, the vicinity of the collector portion of the electrode sheet is likely to concentrate on the electrode reaction, and a liquid shortage is likely to occur. It is expected that, since the groove group having a second pattern is inclined in a direction of the collector portion, a part of the electrolytic solution flows in the direction of the collector portion by deviating from the folded-back portion. Therefore, it is expected that the liquid circulation in the electrode body is improved during rapid charging.

2. The battery according to the “1”, for example, may include the following configuration. The electrode sheets each include a collector foil and an active material layer. The active material layer coats a part of a surface of the collector foil. At least a part of the groove group is a plurality of recessed portions provided in a surface of the active material layer.

For example, the groove group may be formed by performing embossing processing, cutting processing, or the like on the active material layer.

3. The battery according to the “1” or “2”, for example, may include the following configuration. At least a part of the groove group is undulations of the electrode sheet.

For example, the groove group may be formed by undulations occurring in the entire electrode sheet (the collector foil and the active material layer). The undulations may be referred to as, for example, wavy or wrinkled. For example, the undulations may be formed by performing rolling processing a plurality of times on the electrode sheet.

4. The battery according to any one of “1” to “3”, for example, may include the following configuration. In the second pattern portion, the groove group extends in a curved shape.

In the second pattern portion, the groove group extends to draw a curve, which may improve the liquid circulation.

5. A battery according to one aspect of the present disclosure includes an electrode body and an electrolytic solution. The electrode body includes a separator and a plurality of electrode sheets. The separator folded in a zigzag shape has a plurality of folded-back portions. The electrode sheets are stacked such that the electrode sheets are alternately interposed between the folded-back portions. The electrode sheet includes a collector foil and an active material layer. The active material layer coats a part of a surface of the collector foil. A collector portion is provided at an end portion of the electrode sheet. The collector portion is a portion of the collector foil that is not coated with the active material layer. A groove group is provided in a surface of at least one of the electrode sheets. The groove group includes a first pattern portion and a second pattern portion. In a plan view, the second pattern portion is disposed between the collector portion and the first pattern portion. In the first pattern portion, the groove group extends toward the folded-back portion. In the second pattern portion, the groove group extends to be inclined toward the collector portion with respect to the first pattern portion. At least a part of the groove group is undulations of the electrode sheet. In the second pattern portion, the groove group extends in a curved shape.

Hereinafter, an embodiment of the present disclosure (hereinbelow, can also be simply described as “the present embodiment”) will be described. Here, the present embodiment does not limit the technical scope of the present disclosure. The present embodiment is an example in all aspects. The present embodiment is not restrictive. The technical scope of the present disclosure includes all changes within the meaning and the scope that are equivalent to the description of CLAIMS. For example, extracting arbitrary configurations from the present embodiment and arbitrarily combining the configurations are preconceived from the first.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing an example of a battery in the present embodiment;

FIG. 2 is a schematic sectional view showing an example of an electrode body in the present embodiment;

FIG. 3 is a first schematic plan view showing an example of an electrode sheet in the present embodiment;

FIG. 4 is a second schematic plan view showing an example of the electrode sheet in the present embodiment;

FIG. 5 is a first schematic sectional view showing an example of the electrode sheet in the present embodiment; and

FIG. 6 is a second schematic sectional view showing an example of the electrode sheet in the present embodiment.

### DETAILED DESCRIPTION OF EMBODIMENTS

### Terms and Phrases

The terms “comprising”, “including”, “having”, and modifications thereof are open-ended expressions. The configuration expressed in an open-ended manner may further include or may not include an additional element in addition to the essential element. The description of “consisting of” is a closed expression. However, even in the configuration expressed in a closed manner, an impurity that is usually attached or an additional element that is irrelevant to the target technology can be included. The description of “substantially consisting of ~” is a semi-closed expression. In the configuration expressed in a semi-closed manner, addition of an element that does not substantially affect the basic and novel characteristics of the target technology is allowed.

Geometric terms should not be interpreted in a strict sense. Examples of the geometric terms include “parallel”, “perpendicular”, and “orthogonal”. For example, a direction, an angle, a distance, or the like may be relatively displaced within a range in which substantially the same or similar functions are obtained. The geometric terms may include, for example, a tolerance or an error in design, operation, or manufacturing. The dimensional relationships in each drawing may not match the actual dimensional relationships. For the convenience of understanding of the reader, the dimensional relationship in each drawing may be changed. For example, a length, a width, or a thickness may be changed. Some configurations may be omitted.

The expressions such as “first” and “second” are used only to distinguish a plurality of elements from each other. The expression does not limit the elements to which the expression is applied. The expression is, for example, independent of the order or the importance of the elements to which the expression is applied.

For example, the numerical range such as “m% to n%” includes both ends. That is, “m% to n%” indicates a numerical range of “m% or more and n% or less”. “m% or more and n% or less” includes “more than m% and less than n%”. Furthermore, a numerical value arbitrarily selected from a numerical range may be adopted as a new upper limit value or lower limit value. For example, a new numerical range may be set by arbitrarily combining a numerical value within a numerical range with a numerical value described in another part, table, or drawing in the present specification. Regarding the numerical range (interval), for example, “a range formed by any one or two end points selected from the group consisting of a, b, c, and d” includes “a ≤ x”, “x ≤ a”, “b ≤ x”, “x ≤ b”, “c ≤ x”, “x ≤ c”, “d ≤ x”, “x ≤ d”, “a ≤ x ≤ b”, “a ≤ x ≤ c”, “a ≤ x ≤ d”, “b ≤ x ≤ c”, “b ≤ x ≤ d”, and “c ≤ x ≤ d”. Any range may include or may not include the end point. That is, the range includes, for example, not only “a ≤ x” but also “a < x”. The range includes, for example, not only “a ≤ x ≤ b” but also “a < x ≤ b”, “a ≤ x < b”, and “a < x < b”.

The “electrode sheet” is a general term for a “monopolar sheet” and a “bipolar sheet”. The monopolar sheet includes a positive electrode active material layer or a negative electrode active material layer. The monopolar sheet including the positive electrode active material layer may be referred to as a “positive electrode sheet”. The monopolar sheet including the negative electrode active material layer may be referred to as a “negative electrode sheet”. The bipolar sheet includes a positive electrode active material layer on a first surface and a negative electrode active material layer on a second surface. For example, a first electrode sheet may be a positive electrode sheet, and a second electrode sheet may be a negative electrode sheet. Both the first electrode sheet and the second electrode sheet may be a bipolar sheet. The “active material layer” is a general term for a “first active material layer” and a “second active material layer”. The “collector foil” is a general term for a “first collector foil” and a “second collector foil”.

The “plan view” indicates viewing an object with a line of sight parallel to a thickness direction (Z-axis direction in the drawing). The plan view is shown in a plan view. The “groove group” indicates two or more grooves. The “groove” indicates a portion that is recessed in the thickness direction than a periphery in a plan view. In a plan view, the plurality of grooves may be arranged substantially parallel to each other without intersecting each other. The plurality of grooves may not be parallel or may intersect.

### Battery

A battery in the present embodiment may be any battery system. The battery may be, for example, a lithium ion secondary battery, a sodium ion battery, or a nickel-hydrogen battery. The battery may have a monopolar structure or a bipolar structure. The battery includes an electrolytic solution (liquid electrolyte). The battery may include, for example, a gel electrolyte or a solid electrolyte, in addition to the electrolytic solution. That is, the battery may be a liquid battery, a polymer battery, a solid battery, or the like. The “solid battery” indicates a battery including other electrolytes in addition to a solid electrolyte. Hereinafter, as an example, an application example to a lithium ion secondary battery will be described.

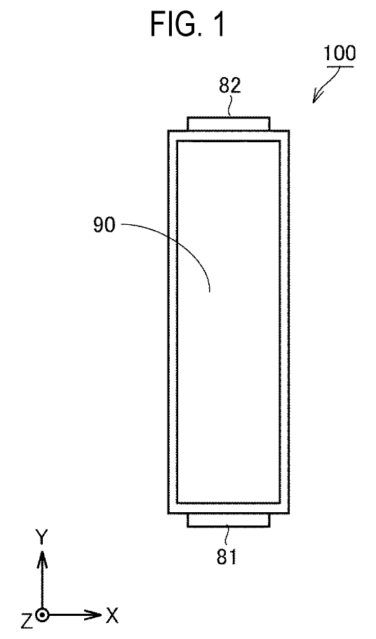

FIG. 1 is a schematic view showing an example of the battery in the present embodiment. The battery 100 may have any outer shape. The battery 100 may have, for example, a plate-like outer shape. A planar shape of the battery 100 may be, for example, a rectangular shape. The battery 100 includes an exterior body 90. The exterior body 90 may have any form. The exterior body 90 may be, for example, a pouch made of an aluminum laminated film, a case made of metal, or the like. For example, in a case where the exterior body 90 is a pouch made of an aluminum laminated film, the periphery may be sealed by being thermally welded.

The battery 100 includes a first electrode terminal 81 and a second electrode terminal 82. The second electrode terminal 82 has a polarity opposite to the first electrode terminal 81. The first electrode terminal 81 is electrically connected to a first collector portion 13 described below. The second electrode terminal 82 is electrically connected to a second collector portion (not shown).

### Electrode Body

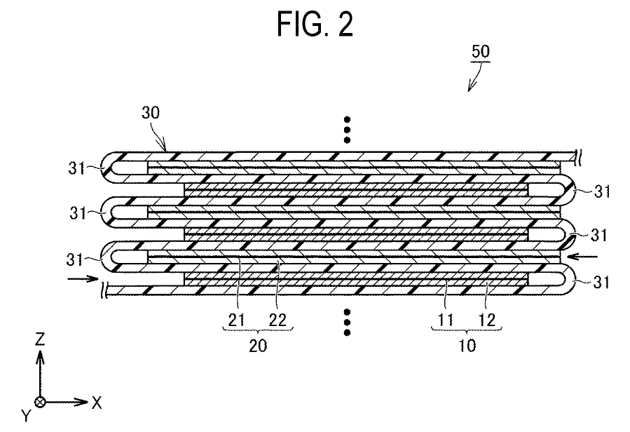

FIG. 2 is a schematic sectional view showing an example of an electrode body in the present embodiment. The exterior body 90 accommodates an electrode body 50 and an electrolytic solution (not shown). That is, the battery 100 includes the electrode body 50 and the electrolytic solution. The electrode body 50 includes a separator 30, a plurality of first electrode sheets 10, and a plurality of second electrode sheets 20. The electrode body 50 has a zigzag structure. A plurality of folded-back portions 31 is formed by folding the separator 30 in a zigzag shape. The first electrode sheet 10 and the second electrode sheet 20 are alternately inserted into the folded-back portions 31. An arrow in the drawing indicates an insertion direction of the electrode sheet. A Z-axis direction in the drawing is a thickness direction and a stacking direction. The first electrode sheet 10 and the second electrode sheet 20 are alternately stacked in the Z-axis direction.

### Electrode Sheet

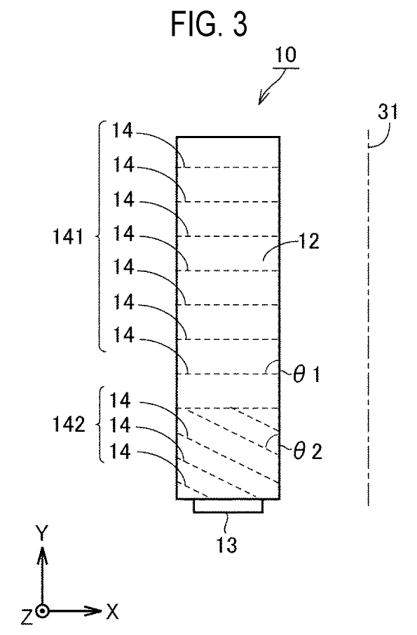

FIG. 3 is a first schematic plan view showing an example of the electrode sheet in the present embodiment. The first electrode sheet 10 includes a first collector foil 11 and a first active material layer 12. The first active material layer 12 coats a part of a surface of the first collector foil 11. For example, in the surface of the first collector foil 11, a region of 80% or more in area ratio (coating ratio) may be coated with the first active material layer 12. The range of the coating ratio may be, for example, a range formed by any one or two end points selected from the group consisting of 80%, 85%, 90%, 95%, and 99%. The range of the coating ratio may be, for example, “80% or more”, “99% or less”, or “80% to 99%”.

The first collector portion 13 is provided at an end portion of the first electrode sheet 10. The collector portion may be referred to as, for example, a “collector tab”. For example, the first collector portion 13 may be a part of the first collector foil 11. For example, the first collector portion 13 may be a portion of the first collector foil 11 that is not coated with the first active material layer 12. For example, a width of the first collector portion 13 may be smaller than a width of the first collector foil 11. The second electrode sheet 20 may include a second collector foil (not shown), a second active material layer (not shown), and a second collector portion (not shown), similarly to the first electrode sheet 10.

In the electrode body 50, a groove group 14 is provided on a surface of at least one electrode sheet. For example, the groove group 14 may be provided on a plurality of first electrode sheets 10, or the groove group 14 may be provided on all of the first electrode sheets 10. For example, the groove group 14 may be provided on a plurality of second electrode sheets 20, or the groove group 14 may be provided on all of the second electrode sheets 20. The groove group 14 may be provided on any one of the first electrode sheet 10 or the second electrode sheet 20, or may be provided on both the first electrode sheet 10 and the second electrode sheet 20.

The groove group 14 includes a first pattern portion 141 and a second pattern portion 142. In a plan view, the second pattern portion 142 is disposed between the first collector portion 13 and the first pattern portion 141. In the first pattern portion 141, the groove group 14 extends toward the folded-back portion 31. A range of an angle (θ1) between the groove group 14 of the first pattern portion 141 and the substantially linear folded-back portion 31 (substantially linear) may be, for example, a range formed by any one or two end points selected from the group consisting of 45°, 60°, 75°, 90°, 105°, 120°, and 135°. The range of the angle (θ1) may be, for example, “45° or more”, “135° or less”, or “45° to 135°”.

In the second pattern portion 142, the groove group 14 extends to be inclined toward a first collector portion 13 side with respect to the first pattern portion 141. A range of an angle (θ2) between the groove group 14 of the second pattern portion 142 and the substantially linear folded-back portion 31 may be, for example, a range formed by any one or two end points selected from the group consisting of 0°, 15°, 30°, and 45°. The range of the angle (θ2) may be, for example, “0° or more”, “45° or less”, or “0° to 45°”. In a case where the second pattern portion 142 is orthogonal to the first pattern portion 141, the flow of the electrolytic solution toward the folded-back portion 31 in the second pattern portion 142 may be excessively hindered, which may deteriorate the liquid circulation.

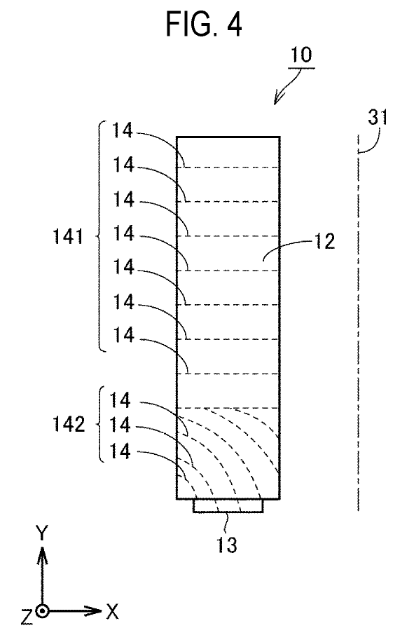

FIG. 4 is a second schematic plan view showing an example of the electrode sheet in the present embodiment. In the second pattern portion 142, for example, the groove group 14 may extend in a linear shape or may extend in a curved shape. In FIGS. 3 and 4, a position of the folded-back portion 31 is indicated by a one-dot chain line. For example, the groove group 14 may be bent to be away from the folded-back portion 31. For example, the groove group 14 may be bent toward the first collector portion 13. The groove group 14 may extend in a parabolic shape. In the groove group 14, a curvature of the curve may be substantially constant. In each groove, the curvature of the curve may be different.

A ratio of a length of the second pattern portion 142 to a total length of the first pattern portion 141 and the second pattern portion 142 in a length direction (Y-axis direction) of the first active material layer 12 may be, for example, a range formed by any one or two end points selected from the group consisting of 0.1, 0.2, 0.3, 0.4, 0.5, 0.6, 0.7, 0.8, and 0.9. The range of the ratio of the lengths may be, for example, “0.1 or more”, “0.9 or less”, or “0.1 to 0.9”.

A spacing (pitch) between the individual grooves may be substantially constant or may be different from each other. For example, the pitch may be different between the first pattern portion 141 and the second pattern portion 142. The range of the pitch may be, for example, a range formed by any one or two end points selected from the group consisting of 0.1 mm, 0.5 mm, 1 mm, 5 mm, 10 mm, and 20 mm. The range of the pitch may be, for example, “0.1 mm or more”, “20 mm or less”, or “0.1 mm to 20 mm”.

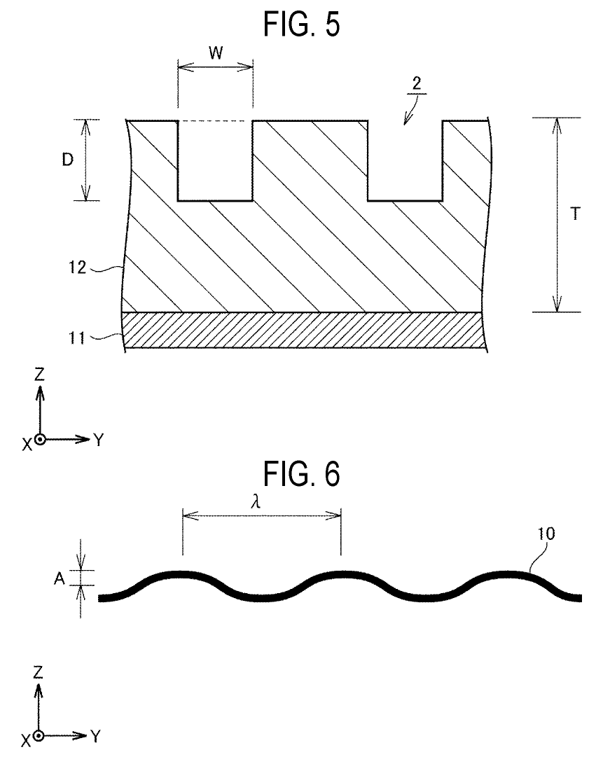

FIG. 5 is a first schematic sectional view showing an example of the electrode sheet in the present embodiment. For example, a plurality of recessed portions 2 may be formed on a surface of the first active material layer 12 to form at least a part of the groove group 14. The recessed portions 2 may be formed by, for example, cutting processing using a laser, pressing processing using an embossing roll, or the like. A range of a ratio “D/T” of a depth “D” of the recessed portions 2 to a thickness “T” of the first active material layer 12 may be, for example, a range formed by any one or two end points selected from the group consisting of 0.1, 0.2, 0.3, 0.4, 0.5, 0.6, 0.7, 0.8, and 0.9. The range of the ratio “D/T” may be, for example, “0.1 or more”, “0.9 or less”, or “0.1 to 0.9”. A range of a ratio “D/W” of the depth “D” of the recessed portions 2 to a width “W” of the recessed portions 2 may be, for example, a range formed by any one or two end points selected from the group consisting of 0.1, 0.2, 0.5, 1, 2, 5, and 10. The range of the ratio “D/W” may be, for example, “0.1 or more”, “10 or less”, or “0.1 to 10”.

FIG. 6 is a second schematic sectional view showing an example of the electrode sheet in the present embodiment. For example, at least a part of the groove group 14 may be formed by undulations of the first electrode sheet 10. In the first electrode sheet 10 of FIG. 6, the entire first collector foil 11 and the first active material layer 12 have a wave shape. A wavelength “λ” of the undulations (waveform) may be substantially constant or may change. The range of the wavelength “λ” may be, for example, a range formed by any one or two end points selected from the group consisting of 0.1 mm, 0.5 mm, 1 mm, 5 mm, 10 mm, and 20 mm. The range of the wavelength “λ” may be, for example, “0.1 mm or more”, “20 mm or less”, or “0.1 mm to 20 mm”.

For example, the wavelength may be different between the first pattern portion 141 and the second pattern portion 142. For example, a wavelength “λ2” in the second pattern portion 142 may be larger than a wavelength “λ1” in the first pattern portion 141. The range of the ratio “λ2/λ1” of the wavelengths may be, for example, a range formed by any one or two end points selected from the group consisting of 1.2, 1.5, 2, 3, 4, 5, and 10. The range of the ratio “λ2/λ1” of the wavelengths may be, for example, “1.2 or more”, “10 or less”, or “1.2 to 10”.

An amplitude “A” of the undulations may be substantially constant or may change. The range of the amplitude “A” of the undulations may be, for example, a range formed by any one or two end points selected from the group consisting of 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, and 5 mm. The range of the amplitude “A” of the undulations may be, for example, “0.1 mm or more”, “5 mm or less”, or “0.1 mm to 5 mm”.

For example, the amplitude may be different between the first pattern portion 141 and the second pattern portion 142. For example, an amplitude “A2” in the second pattern portion 142 may be smaller than an amplitude “A1” in the first pattern portion 141. The range of the ratio “A2/A1” of the amplitudes may be, for example, a range formed by any one or two end points selected from the group consisting of 0.1, 0.2, 0.3, 0.4, 0.5, 0.6, 0.7, 0.8, and 0.9. The range of the ratio “A2/A1” of the amplitudes may be, for example, “0.1 or more”, “0.9 or less”, or “0.1 to 0.9”.

For example, the undulations of FIG. 6 may be formed by rolling processing. For example, the first pattern portion 141 and the second pattern portion 142 may be formed by two-stage rolling processing. For example, “hydraulic 30 t roll press” manufactured by THANK-METAL Co., Ltd. or the like may be used. For example, first rolling processing may be performed on the entire first active material layer 12. The groove group 14 may be formed to extend along a flow direction of the work. A roll temperature in the first rolling processing may be, for example, room temperature. Next, second rolling processing may be performed only on a portion that is to be the second pattern portion 142. A roll temperature in the second rolling processing may be, for example, about 80°C. By the second rolling processing, the first electrode sheet 10 extends in the width direction, so that the second pattern portion 142 in which the groove group 14 is inclined may be formed. In a case where the first active material layer 12 is a positive electrode active material layer, a guide for the density after the rolling may be, for example, about 3.0 g/cm³. For example, as shown in FIG. 4, the undulations (wrinkles) may be formed in the first collector portion 13.

### Battery Material

The collector foil may include, for example, an aluminum foil, a copper foil, or the like. The active material layer may have a thickness of, for example, 10 μm to 1000 μm. The range of the density of the active material layer may be, for example, a range formed by any one or two end points selected from the group consisting of 0.5 g/cm³, 1 g/cm³, 1.5 g/cm³, 2 g/cm³, 2.5 g/cm³, 3 g/cm³, 3.5 g/cm³, and 4 g/cm³. The range of the density of the active material layer may be, for example, “0.5 g/cm³ or more”, “4 g/cm³ or less”, or “0.5 g/cm³ to 4 g/cm³”. The active material layer may include an active material, a conductive material, a binder, and the like. The positive electrode active material may include, for example, at least one selected from the group consisting of a lithium transition metal composite oxide (Li[NiCoMn]O₂) and a lithium phosphate compound (Li[FeMn]PO₄). The description of [NiCoMn], [FeMn], and the like indicates that the total of the compositional ratios of the components in [] is “1”. The compositional ratio of each component is optional as long as the total is 1. For example, the compositional ratio of some components may be zero. The negative electrode active material may include, for example, at least one selected from the group consisting of graphite, silicon, a silicon-based alloy, silicon oxide, and a silicon-carbon composite material (Si-C). Si-C indicates a composite material of silicon and a carbon material. For example, silicon may be supported on carbon particles.

The separator 30 may be, for example, a porous film made of a resin. The separator 30 may include, for example, polyethylene, polypropylene, or the like. The range of the thickness of the separator 30 may be, for example, a range formed by any one or two end points selected from the group consisting of 5 μm, 10 μm, 15 μm, 20 μm, 25 μm, and 30 μm. The range of the thickness of the separator 30 may be, for example, “5 μm or more”, “30 μm or less”, or “5 μm to 30 μm”.

The electrolytic solution may include, for example, an organic solvent and a lithium salt. The organic solvent may include, for example, at least one selected from the group consisting of ethylene carbonate, propylene carbonate, dimethyl carbonate, diethyl carbonate, and ethyl methyl carbonate. The lithium salt may include, for example, LiPF₆.

What is claimed is:

1. A battery comprising:
an electrode body; and
an electrolytic solution, wherein:
the electrode body includes a separator and a plurality of electrode sheets;
the separator folded in a zigzag shape has a plurality of folded-back portions;
the electrode sheets are stacked such that the electrode sheets are alternately interposed between the folded-back portions;
a collector portion is provided at an end portion of each of the electrode sheets ;
a groove group is provided in a surface of at least one of the electrode sheets ;
the groove group includes a first pattern portion and a second pattern portion;
in a plan view, the second pattern portion is disposed between the collector portion and the first pattern portion;
in the first pattern portion, the groove group extends toward the folded-back portion; and
in the second pattern portion, the groove group extends to be inclined toward the collector portion with respect to the first pattern portion.

2. The battery according to claim 1, wherein:
the electrode sheets each include a collector foil and an active material layer;
the active material layer coats a part of a surface of the collector foil; and
at least a part of the groove group is a plurality of recessed portions provided in a surface of the active material layer.

3. The battery according to claim 1, wherein at least a part of the groove group is undulations of the electrode sheet.

4. The battery according to claim 1, wherein in the second pattern portion, the groove group extends in a curved shape.

5. A battery comprising:
an electrode body; and
an electrolytic solution, wherein:
the electrode body includes a separator and a plurality of electrode sheets;
the separator folded in a zigzag shape has a plurality of folded-back portions;
the electrode sheets are stacked such that the electrode sheets are alternately interposed between the folded-back portions;
the electrode sheet includes a collector foil and an active material layer;
the active material layer coats a part of a surface of the collector foil;
a collector portion is provided at an end portion of the electrode sheet;
the collector portion is a portion of the collector foil that is not coated with the active material layer;
a groove group is provided in a surface of at least one of the electrode sheets;
the groove group includes a first pattern portion and a second pattern portion;
in a plan view, the second pattern portion is disposed between the collector portion and the first pattern portion;
in the first pattern portion, the groove group extends toward the folded-back portion;
in the second pattern portion, the groove group extends to be inclined toward the collector portion with respect to the first pattern portion;
at least a part of the groove group is undulations of the electrode sheet; and
in the second pattern portion, the groove group extends in a curved shape.
